(19) United States
(12) Patent Application Publication
(10) Pub. No.: US 2026/0072962 A1
(43) Pub. Date: Mar. 12, 2026

(54) EVALUATING MULTIMODAL RETRIEVAL AUGMENTED GENERATION PERFORMANCE

(71) Applicant: NEC Laboratories America, Inc., Princeton, NJ (US)

(72) Inventors: Mohammad Khojastepour, Lawrenceville, NJ (US); Srimat Chakradhar, Manalapan, NJ (US); Matin Mortaheb, College Park, MD (US)

(21) Appl. No.: 19/319,030

(22) Filed: Sep. 4, 2025

Related U.S. Application Data
(60) Provisional application No. 63/691,454, filed on Sep. 6, 2024.

(51) Int. Cl. G06F 16/334; G06F 16/3329; G06F 16/353

(52) U.S. Cl. CPC G06F 16/334; G06F 16/3329; G06F 16/353

(57) ABSTRACT

Systems and methods for evaluating multimodal retrieval augmented generation (RAG) performance. The systems and methods include generating an internal response from a user input and a RAG database and generating a relevancy score for quantifying a relevance of the internal response to information retrieved from the RAG database based on the user input and a correctness score quantifying accuracy of the internal response to the information retrieved from the RAG database. The systems and methods further include generating a combined score from the relevancy score and correctness score and selectively performing a task based on the relevancy score, the correctness score, or the combined score.

### RELATED APPLICATION INFORMATION

This application claims priority to U.S. Provisional Patent Application 63/691,454, filed on Sep. 6, 2024, incorporated herein by reference in its entirety.

### BACKGROUND

### Technical Field

The present invention relates to reducing hallucinations in large language models and more particularly applying retrieval augmented generation to improve large language model outputs.

### Description of the Related Art

One problem related to artificial intelligence (AI) is hallucinations (e.g., incorrect or irrelevant responses that the AI model asserts as correct and relevant without any indication of uncertainty in the response). These hallucinations can appear accurate and relevant without further investigation because the responses appear convincing. To reduce the effects of hallucinations in AI models, new techniques have been deployed.

Solutions in the prior art have provided means to evaluate and measure the correctness of large language models (LLMs) to a given a text query. One solution demonstrates that breaking long statements into fine-grained atomic statements can improve the identification of hallucinations. This method allows for verification of each individual statement against the source material. Another solution detects context hallucinations by analyzing the attention scores of the corresponding LLM by calculating a ratio between query tokens and response tokens to identify parts of the response that may not be adequately supported by the context.

### SUMMARY

According to an aspect of the present invention, a method is provided for evaluating multimodal retrieval augmented generation (RAG) performance. The method includes generating an internal response from a user input and a RAG database and generating a relevancy score for quantifying a relevance of the internal response to information retrieved from the RAG database based on the user input and a correctness score quantifying accuracy of the internal response to the information retrieved from the RAG database. The method also includes generating a combined score from the relevancy score and correctness score and selectively performing a task based on the relevancy score, the correctness score, or the combined score.

According to another aspect of the present invention, a system is provided for a processor and a memory storing computer-readable instructions. The memory causes the processor to generate an internal response from a user input and a RAG database and generate a relevancy score for quantifying a relevance of the internal response to information retrieved from the RAG database based on the user input and a correctness score quantifying accuracy of the internal response to the information retrieved from the RAG database. The memory also causes the processor to generate a combined score from the relevancy score and correctness score and selectively perform a task based on the relevancy score, the correctness score, or the combined score.

According to yet another aspect of the present invention, a computer program product comprising a non-transitory computer-readable storage medium containing computer program code, the computer program code when executed by one or more processors causes the one or more processors to perform operations. The operations including, causing the processors to generate an internal response from a user input and a RAG database and generate a relevancy score for quantifying a relevance of the internal response to information retrieved from the RAG database based on the user input and a correctness score quantifying accuracy of the internal response to the information retrieved from the RAG database. The computer program code also causes the processors to generate a combined score from the relevancy score and correctness score and selectively perform a task based on the relevancy score, the correctness score, or the combined score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for a multi-modal RAG AI model, in accordance with an embodiment of the present invention;

FIG. 2 is a block diagram of the multi-modal RAG AI model illustrated in greater detail, in accordance with an embodiment of the present invention;

FIG. 3 is a block diagram of a RAG AI model output evaluator, in accordance with an embodiment of the present invention;

FIG. 4 is a block diagram for generating a relevancy score of the RAG AI model output, in accordance with an embodiment of the present invention;

FIG. 5 is a block diagram for checking the RAG AI model output, in accordance with an embodiment of the present invention;

FIG. 6 is a flow diagram for determining the relevance and correctness of the RAG AI model output, in accordance with an embodiment of the present invention;

FIG. 7 is a block diagram illustrating a computer environment for determining the RAG AI model output relevance and correctness, in accordance with an embodiment of the present invention; and

FIG. 8 is a block diagram illustrating an artificial neural network employed, in accordance with an embodiment of the present invention.

### DETAILED DESCRIPTION OF PREFERRED EMBODIMENTS

Artificial intelligence (AI) models have been known to hallucinate results. This is problematic with the rise in popularity of generative AI, where reliance on the output of AI models has increased but diligence to verify output veracity has not. In some cases, some portions of an output are inaccurate or irrelevant, but other portions are not (e.g., some portions are accurate or relevant). If the inaccurate or irrelevant portions are in the middle of an output, the hallucination can be overlooked and can be assumed to be accurate. Embodiments of the present invention reduce or eliminate these hallucinations.

Additionally, AI models have begun publishing information, e.g., on the internet, that future AI models can train on, thereby creating an opportunity for the hallucinations to be perpetuated. This can lead to model collapse, bias amplification, and data poisoning, as well as the problems normally associated with publishing incorrect information that is assumed to be correct. Preventing hallucinations by evaluating AI model outputs before the outputs are relied upon can aid in reducing, preventing, limiting, and/or eliminating these problems.

To increase the utility and trust of AI model results, embodiments of the present invention reduce the hallucinations of AI models using Retrieval Augmented Generation (RAG) which can provide context to AI models when generating outputs (responses).

Retrieval-Augmented Generation (RAG) systems improve AI models responses (particularly Large Language Models (LLMs)) by integrating external knowledge sources on which a user intends the responses to be based. In RAG systems, external knowledge such as enterprise data is stored in a database. When the user submits a query, the RAG system retrieves a several relevant and similar pieces of data from the database. The LLM then generates a response based on this information. This approach reduces hallucinations by constraining the LLM to generate responses grounded in the provided external knowledge, thereby increasing accuracy and relevance. Currently, there are no RAG systems that prevent hallucinations for multi-modal RAGs, where the context includes multiple pieces of multimodal data e.g., multiple images, images and text. In other words, RAG systems in the prior art focus on LLMs rather than generative AI models outside the context of text.

Some RAG systems work by selecting k entries from the database that have the highest similarity to a user query (e.g., top-k approach). A common approach is to select the k entries whose embeddings have the highest cosine similarity to the query embedding, referred to as the top-k entries. However, this method of selection does not always retrieve the most relevant data for the user query. The wrong selection can result in an incorrect response since the LLM is not otherwise aware of the correct information.

Another source of hallucination in the retrieval process is during context generation in the RAG scheme. For example, when multi-modal RAG systems are tasked with processing the selected pieces of information to generate a text-based context, the context can be incorrect. This incorrect context is then provided to an LLM along with the query to produce the response and can ultimately lead to an incorrect response since the AI model did not have the correct context. This is referred to as context-generation-hallucination.

Multi-modal RAG systems present challenges to existing solutions, including RAGs, as they integrate information from various visual sources along with the text to generate coherent and accurate responses. Embodiments of the present invention check RAG outputs to evaluate the performance of multi-modal RAG schemes. This “response evaluator” includes several components including a partitioner that spans the response or the retrieved entry from the database, a structure to compute a relevancy score between a prompt (or query) and a piece of information, and a structure to computer a correctness score between a prompt or query and a piece of information, e.g., a span of the response. The piece of information can be multimodal, e.g., text, voice, image, video, etc. The piece of information can be the entire record or part of the retrieved record from the database by the RAG system.

A neural network structure is designed and trained to generate a relevancy score from selected pieces of data from the RAG scheme. This can be done by applying the internal components of a RAG system and producing a relevancy score between each selected piece and the query. For example, when an image (or text) is selected, Relevancy score evaluates how relevant the retrieved image (or text) is to the user query. By assigning a relevancy score to each image, a determination can be made as to how well the visual data aligns with the intent of the user and the specific information requested.

Another component partitions the output response by the RAG into segments “spans,” categorizes each span, and evaluates the truthfulness (correctness) of the spans. The span can be defined as statements, phrases, etc. Some spans are not scorable, e.g., if the span is based on personal opinions and feelings rather than on facts. Alternatively, a span is not scorable if the span states an analysis, e.g., a conditional statement, or an expression of uncertainty such as the possibility or probability of something being true. Such statements are labeled as “subjective” which have been also referred to as “analysis” type in the prior art. A span that is not subjective, i.e., a span that is scorable, is labeled as “objective.”

Partitioning text into spans identifies which part of the generated response is incorrect and can identify portions that are more important, valuable, or otherwise consequential to the output than others and apply more weight in evaluating the correctness score for the entire response. For example, an input that is a layered question can weigh the foundational questions more than the secondary questions upon which they rely. A feedback loop can also be used to prompt the RAG system with partial set of spans in order to generate new and improved results.

Another component designs and trains a neural network structure to assess the correctness of each objective span in the view of the selected pieces of the data by the RAG. In multimodal RAGs, the selected pieces can be first used to generate the context, e.g., by using VLM for the images, and then will be used by an LLM to generate the response based on the query. In alternative embodiments of the present invention, the selected pieces can be directly fed to a multi-modal LLM (MLLM) to generate the response based on the query. Irrespective of the internal structure of the RAG system, a correctness score assesses the accuracy of each span of the generated text with the original data for each selected piece. The correctness score measures how correct each part of the response reflects the information presented in the retrieved context (images, etc.). By evaluating the correctness of the text spans, the accuracy is evaluated as well as the relevance of the multimodal data.

The relevancy score and correctness score can be used to evaluate the confidence the AI model has for each span. The relevancy score ensures that the retrieved images are pertinent to the query, while the correctness score verifies that the textual response accurately represents the information from the images. The combined evaluation based on the relevancy score and the correctness score provides comprehensive measures of the reliability of the responses generated by multi-modal RAG system, ensuring both relevance and correctness of the response. These scores may be combined in the form of a tuple or a single metric, though other data structures are also contemplated.

For example, a confidence score (metric) may be defined as the multiplication of the average relevancy scores over all spans of the retrieved information and the average correctness scores over all spans of the generated response. The relevancy score, correctness score, or confidence score may be used in decision making, e.g., to control a robot, or perform online transactions. Scores can be used to make informed decisions like executing a given action if the relevancy score, correctness score, or confidence score are above a given value. For example, if a prompt includes “is this something serious” and includes a picture of a potential injury, if the confidence score is high enough (that the image includes an injury-correctness, and the injury is serious-relevance), the model can recommend appropriate measures like directions to a medical practitioner, or ordering the appropriate medical supplies. Another possible use for applying the scores is changing settings depending on the scores. For example, a camera can be sending a live video feed to the model of a television. Based on the images received by the camera, compared to expected values in the RAG database, the settings on the television can be adjusted. These scores can also be used to improve the performance of a RAG system by using algorithms like gradient descent to optimize the prompt and to enhance the retrieval method.

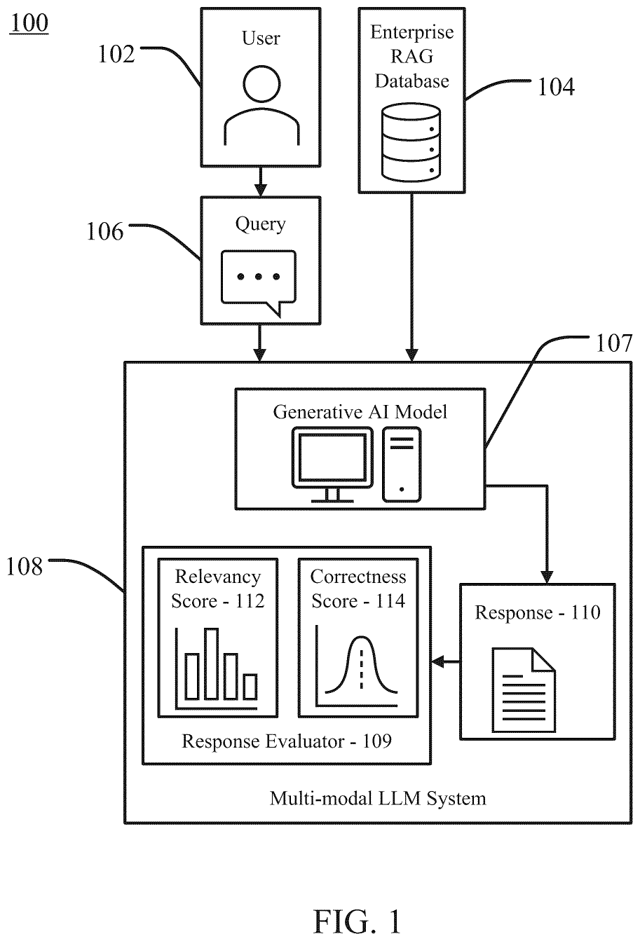

Referring now in detail to the figures in which like numerals represent the same or similar elements and initially to FIG. 1, a high-level block diagram for a multi-modal RAG is illustrated. A user 102 supplies a query 106 to a multi-modal LLM system 108. Multi-modal LLM system 108 can include generative artificial intelligence (GenAI) model 107. GenAI model 107 can include text models such as, e.g., RAG framework 100, but can also be a visual language model (VLM), or include other types of data such as audio files, video, speech, code, time series data, tabular data, three dimensional data (e.g., computer aided design (CAD) files), haptic data, gestures, or a fusion of sensors to be a multi-model LLM, etc., Other types of data are also contemplated.

In an embodiment of the present invention, multi-modal LLM system 108 can reduce hallucinations of GenAI model 107 using RAG methodologies. Multi-modal LLM system 108 can evaluate query (e.g., an input) 106. GenAI model 107 can receive query 106 to derive (e.g., generate) a response 110, which can be an image, sound, text passage, etc. Multi-modal LLM system 108 can use an enterprise RAG database 104 to add contextual information to query 106 to reduce and/or eliminate hallucinations.

Multi-modal LLM system 108 can evaluate response 110 based on enterprise RAG database 104 and query 106 to determine a relevancy score 112 and a correctness score 114. Relevancy score 112 can determine (e.g. evaluate) the performance of the selection process of response 110 in response evaluator 109. Relevancy score 112 can provide the quantitative measure between zero (least relevant) and one (most relevant) for each retrieved piece of information from enterprise RAG database 104. Response 110 be broken down into smaller pieces to assess the relevancy to query 106 more granularly. In some embodiments of the present invention, those pieces of information can be broken down several times until the information meets a certain criterion to improve the efficacy of RAG framework 100. The breakdown of the text response of the LLM is based on paragraphs, sentences, or phrases. In some cases, a sentence may also be broken down into two or more independent sentences.

Correctness score 114 determines performance of the generation process of response 110. Response 110 is broken down into smaller pieces, namely spans, and uses the spans to calculate correctness score 114 for a portion of response 110 in response evaluator 109 along with relevancy score 112. The spans can be categorized as either subjective (e.g., opinion; debatable; vague; unclear; human feelings; subject to personal viewpoints, experiences, or perspectives, etc.) or objective (e.g., factual, certain, clear, undeniable, etc.).

Enterprise RAG database 104 can include enterprise data, such as proprietary information, client information, company calculated information, or otherwise publicly unknown information. Alternatively, the information in enterprise RAG database 104 can include supplemental information that is known publicly but has not been incorporated into GenAI model 107. In further embodiments of the present invention, enterprise RAG database 104 can include information on the internet or other sources that can supplement GenAI model 107 until there is a new update on the model with additional training data or model weights. In other words, enterprise RAG database 104 can assist GenAI model 107 to specialize for a given purpose or add utility and not be specialized depending on the context. In other embodiments of the present invention, enterprise RAG database 104 can be used by individuals rather than business entities. User 102 can also customize enterprise RAG database 104 by adding personal information or other non-publicly known information. The enterprise RAG database can hold policies, operation records, technical reports, reports of internal activities such as summits, meetings, conferences, etc.

Enterprise RAG database 104 can be pre-processed by partitioning the data into pieces and generating embeddings for each piece of data. The pre-processing can apply to static or quasi-static enterprise data. When the enterprise data includes time varying or dynamic data, a specialized scheme can be used to reduce the overhead of such pre-processing in generation of the embeddings. For example, based on a query, part of the unprocessed enterprise data can be selected for processing.

The use of embeddings can serve a number of purposes. For example, the embeddings can form a compact representation of each piece of information to enhance the retrieval process for multi-modal LLM system 108. Embeddings are preferred over text-based searches between data and queries, even for text data that is not lengthy, though both are possible and contemplated. Another purpose for embeddings can be to increase retrieval speeds by using a similarity search using dot product (e.g., cosine similarity).

Cosine similarity is a measure of similarity between two non-zero vectors defined in an inner product space. Cosine similarity is the cosine of the angle between the vectors, that is, the measure is the dot product of the vectors divided by the product of their lengths. In relevancy score 112, the values can range from 0≤x≤1. Two embeddings that are the same concept will have a value of 1 while two concepts that are completely unrelated will have a value of 0.

Alternatives to cosine similarity can be implementations of one or more of, e.g., Euclidean Distance, Manhattan Distance, Minkowski Distance, Chebyshev Distance, Pearson Correlation Coefficient, Spearman's Rank Correlation, Jaccard Similarity Coefficient, Dice Similarity Coefficient, Hamming Distance, Kullback-Liebler Divergence, Jensen-Shannon Divergence, Levenshtein Distance, Jaro-Winkler Distance, etc.

In RAG framework 100, depending on the type of data, embeddings can be derived via corresponding encoders. The embedding can have the same embedding space in order to facilitate searching. In an embodiment of the present invention, a contrastive language image pre-training (CLIP) space can be used to generate embeddings for visual data. Other visual embedding methods can include convolutional neural networks (CNNs), bootstrapped language image pre-training (BLIP), vision transformers (ViTs), etc. Text data can be encoded using word embeddings, contextual embeddings, sentence and document embeddings, hashing, etc. Categorial data can be embedding using one-hot encoding, label encoding, neural networks, etc. Numerical data can be embedded using normalization or scaling, direct use as part of a vector, binning, neural networks, etc. Audio data can be embedded using feature extraction, recurrent neural networks (RNNs), long short term memory, gated recurrent units (GRUs), CNNs, transformer models, or pre-trained audio modes. Video data can be embedded using frame-based CNNs, three dimensional CNNs, RNNs, LSTMs, GRUs, transformer models, multimodal embeddings, etc.

In an embodiment of the present invention, each image in the enterprise RAG database 104 is embedded using the CLIP vision encoder (CLIP-VE), and each piece of the text is embedded using the CLIP text encoder (CLIP-TE). The same goes for the query, i.e., the image and text are embedded using CLIP-VE and CLIP-TE, respectively. For example, a text-based query can be embedded using CLIP-TE and then the cosine similarity can be found between the embedding of the query and the embeddings in the vector enterprise RAG database 104, irrespective of the original data type.

After the pre-processing, enterprise RAG database 104 can include pairs of embeddings and the reference to each information upon which the embedding is derived.

Multi-modal LLM system 108 can also select and generate information. A selection block retrieves the relevant pieces of information from enterprise RAG database 104 by performing a cosine similarity search using the embeddings for each piece of the data. The selection process can be enhanced both in overhead and performance by using a hierarchical vector database and knowledge graph. The additional information in the structure of hierarchical vector databases and knowledge graph in comparison to plain vector database can be the source of enhancements in selection processes.

The selection process can determine the retrieved context which is comprised of the corresponding original pieces of the data for the top-k (for a given integer k) entries in terms of the cosine similarity. The selection process can be evaluated by relevancy score 112 (e.g., how relevant the retrieved documents are). Relevancy score 112 can be used to directly perform the selection process instead of using cosine similarity.

A generation block which takes the retrieved context and generates response 110 based on the query 106 in GenAI model 107. In alternative embodiments of the present invention, the generation block can include engines that generate a text-based context for each piece of retrieved data, which is then collectively used as input to a LLM to generate response 110. In other words, response 110 can be generated from query 106 together with the pieces of retrieved data from enterprise RAG database 104 which are used in GenAI model 107 to generate response 110. The generation process can be evaluated by correctness score 114 (e.g., which parts of response 110 are supported by the RAG context).

Multi-modal LLM system 108 can provide feedback to user 102 such as indicating the relevancy score 112 and correctness score 114. Additionally, multi-modal LLM system 108 can recommend how to improve query 106 or otherwise receive a better response 110 such as including more precise or technical jargon to a question, wording query 106 to be less vague, add more specific direction to query 106, etc. Multi-modal LLM system 108 can also automatically modify query 106 to offer several alternative queries 106 that are associated with responses 110 with improved relevancy scores 112 and correctness scores 114.

These alternatives can be visualized, heard through a text-to-speech program, or otherwise conveyed to user 102. Multi-modal LLM system 108 can also record patterns in queries 106 made and suggest improvements to enterprise RAG database 104 and GenAI model 107 accordingly. For example, if many of the queries 106 entered into GenAI model 107 are directed towards visual question answering (VQA) on birds and other flying objects, Multi-modal LLM system 108 can note of the pattern and recommend that additional ornithology and entomology information be included in the future.

The patterns can be noticed through AI or conventional computing (computing without AI). The AI included can be an artificial neural network (ANN) such as RNNs, CNNs, generative adversarial network (GAN), transformers, etc. Other methods can include descriptive statistics, hypothesis tests, regression analysis, time series analysis, control charts, decision trees, support vector machines, logistic regression, clustering, dimensionality reduction, association rule mining, semi-supervised learning, reinforcement learning, rule-based systems (e.g., if-then rules, regular expressions, signatures), proximity-based methods, visual graph representations, graph-based pattern detection, etc.

Embodiments of the present disclosure reflect VLM models as GenAI model 107 however, this is for demonstration purposes, other types of data can be used without visual or text data, or in addition to visual and text data.

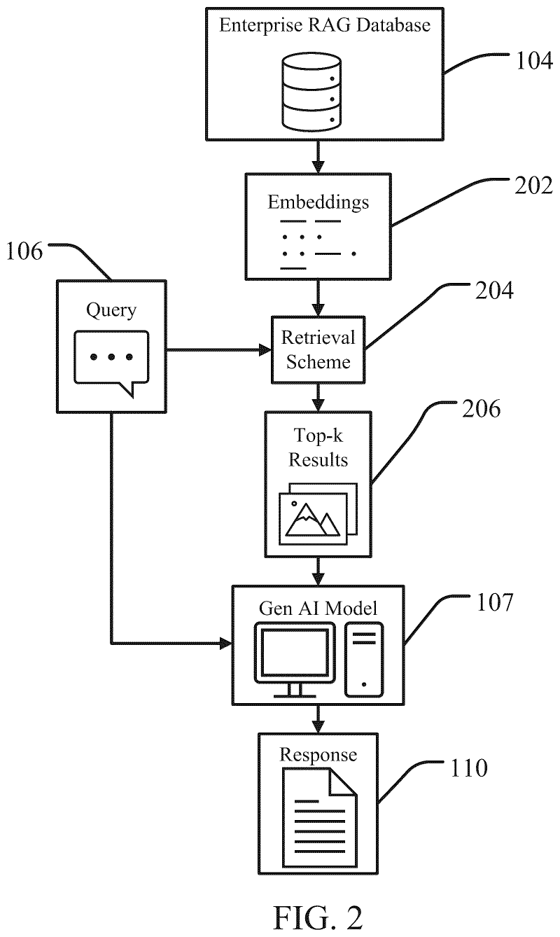

Referring to FIG. 2, a block diagram for the multi-modal RAG is illustrated in greater detail. Enterprise RAG database 104 can include image, text, video, audio, CAD and other three-dimensional data, and other types of data. The data within enterprise RAG database 104 can be embedded to form embeddings 202, which are used in retrieval scheme 204. Retrieval scheme 204 applies the RAG to provide top-k results 206. Top-k results 206 includes an illustrative embodiment, other implementations are also contemplated such as re-ranking, hybrid searches, graph-based retrieval, query expansion and rewriting, context-aware retrieval (conversational RAG), fine-tuned retrievers, multi-vector retrieval, etc.

Relevancy score 112 is determined for each selection of top-k results 206. Response 110 is broken down into several spans. One span can be subjective, while two more are objective. The two objective spans are scored for correctness score 114. Depending on the type of span defined (phrase, atomic statement, sentence, or paragraph), response 110 is spilt into those spans.

Atomic statements as full sentences that are self-sufficient in expressing a meaning without the need to be evaluated along with another sentence or part of the original text. For example, in response 110 “in the image, the desk is red and shiny. It is made of wood that is decorated with nice inlays.” The second sentence in response 110, the personal pronoun “it” has to be replaced with “the desk” to make this statement self-sufficient without the need to be evaluated with the first statement.

The subjective spans are not scored. Subjective spans can be classified as statements that include modal verbs (e.g., “could,” “might”), opinion indicators (e.g., “believe,” “feel”), hedging phrases (e.g., “it seems,”), uncertain quantifiers (e.g., “some,” “many”), adverbs of frequency and degree (e.g., “often,” “usually”), judgmental adjectives (e.g., “important,” “useful”), conjectures (e.g., “it is possible that”), and comparisons or preferences (e.g., “better,” “prefer”).

Query 106 can be input into retrieval scheme 204 to provide information to determine the most appropriate top-k results 206. Additionally, query 106 can be input into GenAI model 107. GenAI model 107 can include both a VLM and an LLM. In other embodiments, other generative AI models can be included or can replace either the VLM or LLM.

Top-k results 206 are then fed into GenAI model 107. In some embodiments of the present invention, top-k results 206 are fed into the VLM which provides context for the LLM. RAG framework 100 (FIG. 1) receives query 106 along with the context to provide response 110. Retrieval scheme 204 and top-k results 206 can be considered a selection process while the VLM and LLM can be considered a context and generation process.

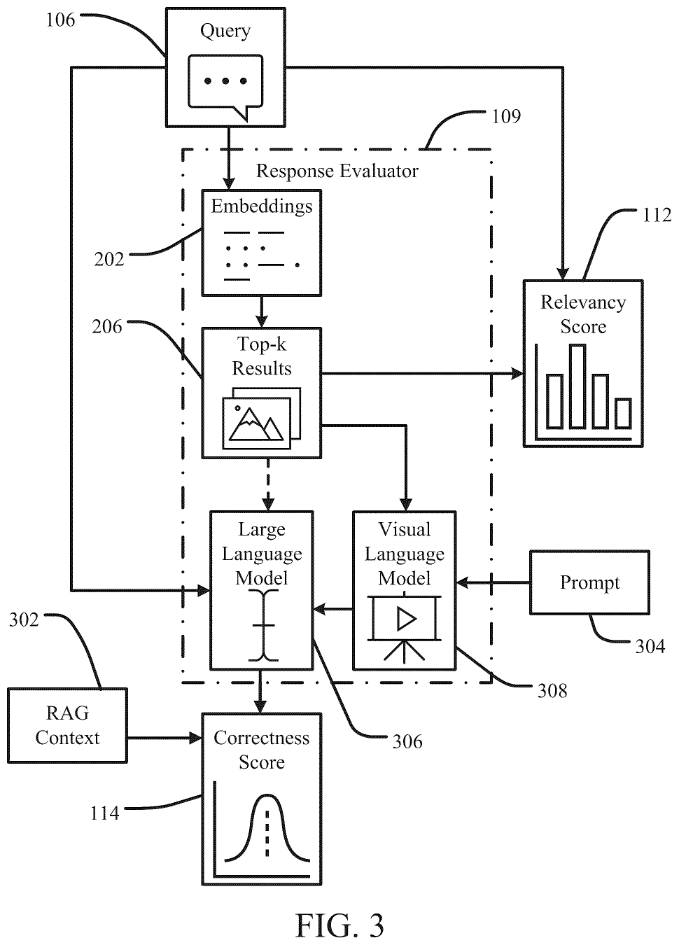

Referring to FIG. 3, response evaluator 109 is illustrated in greater detail. Query 106 is input into response evaluator 109 which performs the functions of a traditional RAG as well as additional capabilities including forming relevancy score 112 and correctness score 114. Query 106 is input into embeddings 202 to identify embedding vectors which select top-k results 206. Correctness score 114 can be determined based on top-k results 206. This means that correctness score 114 can be considered in the view of the top-k information that is provided to the generative process to produce the output. Hence, if incorrect information is given as a context, and the output reflects the same, then correctness score 114 is high and the output is considered correct in the view of the information that is provided. Top-k results 206 can also input into VLM 308. Top-k results 206, in a non-limiting embodiment can be for 5 results. In alternative embodiments of the present invention the top-k results can be 10 results or any other number appropriate for the situation.

VLM 308 can also receive prompt 304. Prompt 304 can request VLM 308 to perform a task such as describing an image or VQA. Other types of prompt 304 are contemplated such as captioning, object recognition and localization, attribute recognition, activity or event recognition, scene understanding, sentiment analysis, image generation, image editing, visual storytelling, generation of variations, image search, text search within images, cross modal search, instruction following, environmental understanding, explain concepts visually, generate analogies, etc.

The result from VLM 308 can be input into LLM 306 along with query 106. Relevancy score 112 can be derived from the output of LLM 306. RAG context also is used in deriving relevancy score 112. Relevancy score 112 provides a measure of relevance between query 106 and each piece of RAG context 302 from the enterprise data. The relevancy in response evaluator 109 can be measured through cosine similarity between embeddings 202 in some embedding space. Embodiments of the present invention relate similarities between different data modalities and other measures can determine the similarity of embeddings 202.

Relevancy score 112 is obtained between query 106 and each piece of the RAG context 302 (e.g., an image) from enterprise RAG database 104 separately. Therefore, a model is designed and trained to receive an image and query 106 as an input and return a relevancy score 112 as a measure of the relevancy between an image and the query. Alternative embodiments of the present invention can use cross-attention between query 106 and the image in a transformer instead of cosine similarity.

Once the transformer module is designed properly, the output contains information about the relevancy between query 106 and the image. Then, a neural network head is trained to extract this information out of the produced embedding by the cross-attention module in the form of a single real number between zero (representing no relevance) and one (representing complete, total relevance).

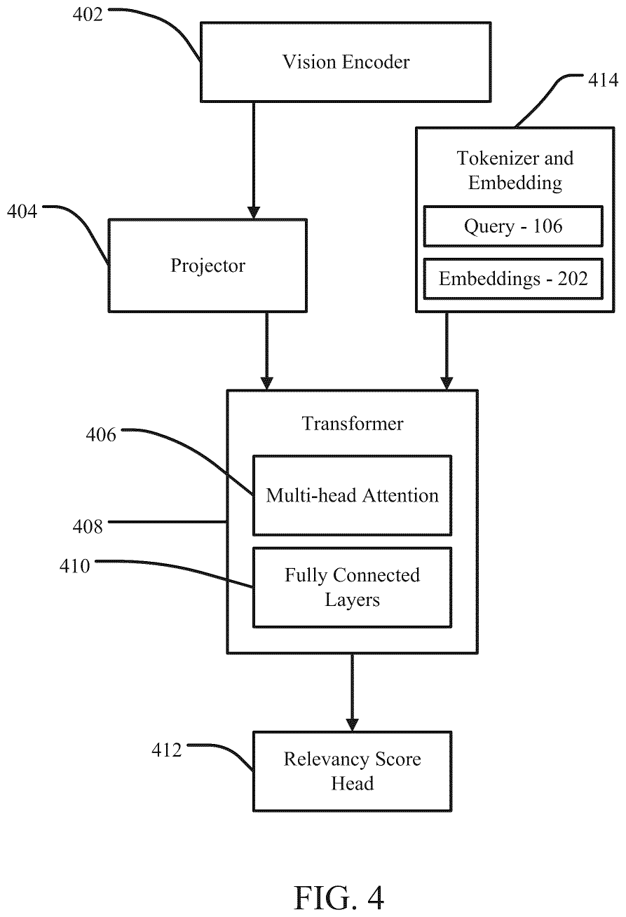

Referring to FIG. 4, a block diagram representing how to train for relevancy score 112 is illustrated. Vision encoder 402 encodes patches of images separately. In an embodiment of the present invention CLIP large can be used as vision encoder 402, which has a transformer architecture to encode image patches. This can also serve as a basis for comparison between the proposed relevancy score 112 and a score which is based on the cosine similarity between the pair of embeddings. While cosine similarity is show in the similarity between a pair of embeddings, it is also used as a measure of relevancy of an embedding to another embedding.

Projector 404 converts the embeddings to a form that transformer block 408 can apply. Tokenizer and Embedder 414 tokenize text in accordance with text query 106 and maps the text to embedding 202. Some tokens can have special treatment. For example, if the query contains a special image token (<Image>), the token will be replaced with the embeddings of the patches. This means that both text and image can be translated to the internal language of the LLM in the form of the embedding. If there is no reference to an image, the system will add image embeddings 202 to the beginning of user query 106 embeddings 202. As a result in total, there are N+P embeddings 202 where N is the number of user query 106 tokens (with the exception of special tokens) and P is the total number of patches. The embedding 202 space is d dimensional, e.g., each embedding 202 has a dimension, d.

Transformer 408 includes multi-head attention 406 and fully connected layers 410. The entire N+P embeddings 202 are processed by transformer 408, which contains L transformer blocks each including multi-head attention 406 with H attention heads and fully-connected layers 410. Multi-head attention 406 can be used to find the relation between different patches of image and user query 106. The output of transformer 408 is a vector of N+P each with d dimension.

Relevancy score head 412 receives the last token generated from transformer 408, e.g., y_{N+P}. Relevancy score head 412 is a fully connected layer that maps dimension d to 1 which is trained to represent relevancy score 112 (FIG. 1).

Training the entire model from scratch to learn both language and the relationship between language and images uses significant amounts of data and computational power. Therefore, weights are leveraged from the current state-of-the-art model. This means that the weights are either randomly initialized or for faster convergence, the weights are initialized based on an available model and then trained. To train the relevancy score 112 model (specifically relevancy score head 412), a training dataset consisting of triplets (J, Sₚ, Sₙ) is used, where J is the image, sₚ is a positive statement about the image J, and Sₙ is a negative statement about the image J.

Relevancy score 112 model can be defined as M. The output of the model with the given statement s is a vector y=M (J; s) of dimension N+P. For the sake of brevity, y−1=M (J; s) represents the last output of the model given an image and a statement. In other words, y−1 is the input to relevancy score head 412. In some embodiments of the present invention, each query can include a template to state “Evaluate the relevancy of the given statement with the image <image>. Evaluate by either ‘relevant’ or ‘irrelevant.’ The statement is: s.”

Embodiments of the present invention use a modified version of a reinforcement learning with a human feedback (RLHF) loss function to train relevancy score 112 model. In a generic RLHF model, even though there is data indicating both highly preferable and less preferable instances, the loss function only ensures that the highly preferable instance receives a higher score than the less preferable one, and there is no lower or upper bound of the loss function. Embodiments of the present invention modify RLHF such that a score is assigned that falls within the range of [0, 1] for any given statement and image. This is implemented by modifying the RLHF loss function to be

L=log(σ(y₋₁(J,sₚ))−σ(y₋₁(J,sₙ))),

where σ is the softmax operator. During the inference, given a pair of (J, q), relevancy score 112 can be obtained as σ(y₋₁ (J,q)). Using such modifications for RLHF allows for faster convergence of the model and better performance. This faster convergence of the model can improve a computer by reducing memory usage, reducing computing time, and computing resources, among other benefits.

Referring to correctness score 114, when the RAG response is generated, the response is partitioned into atomic statements to break the entire generated response into the spans. The atomic statements can be defined as {sᵢ}ᵢ₋₁^{L}, where L is the number of spans. Each of the atomic statements are categorized and marked as subjective or objective. For objective statements, correctness score 114 models obtain are used. For each statement, the correctness score 114 model receives all retrieved images along with the statement for the correctness measure evaluation. The correctness factor takes a context (e.g., a set of images, or text, or both) and a span from the output text and provides correctness score 114 between the span of the output and the context.

Correctness score 114 model and relevancy score 112 model vary in their ability to work with multiple images rather than a single image (correctness score 114 being capable of working with multiple images while relevancy score 112 cannot).

The training process for the dedicated LM head used in the correctness score 114 model is similar relevancy score head 412. The initial template “I am giving you k images. Evaluate this statement with these images and answer by either ‘correct’ or ‘incorrect’: sᵢ.” When there is no reference to a piece of context, correctness score 114 is found between the statement and the entire retrieved context. However, in the calculation of correctness score 114 for a statement that has particular references to pieces of the context, correctness score 114 is found between the statement and the referred pieces of the context in the statement.

For example, if an evaluation of the statement: sₖ=“A boy with a cowboy hat is riding a white house in <image1>,” correctness score 114 is computed by using the template: “I am giving you a statement. Evaluate this statement and answer by either ‘correct’ or ‘incorrect’: sₖ,” where the embeddings of image 1 are inserted in the position of the token <image1>. Correctness score 114 can also be trained for the images and text input. Correctness score 114 is derived from a trained model.

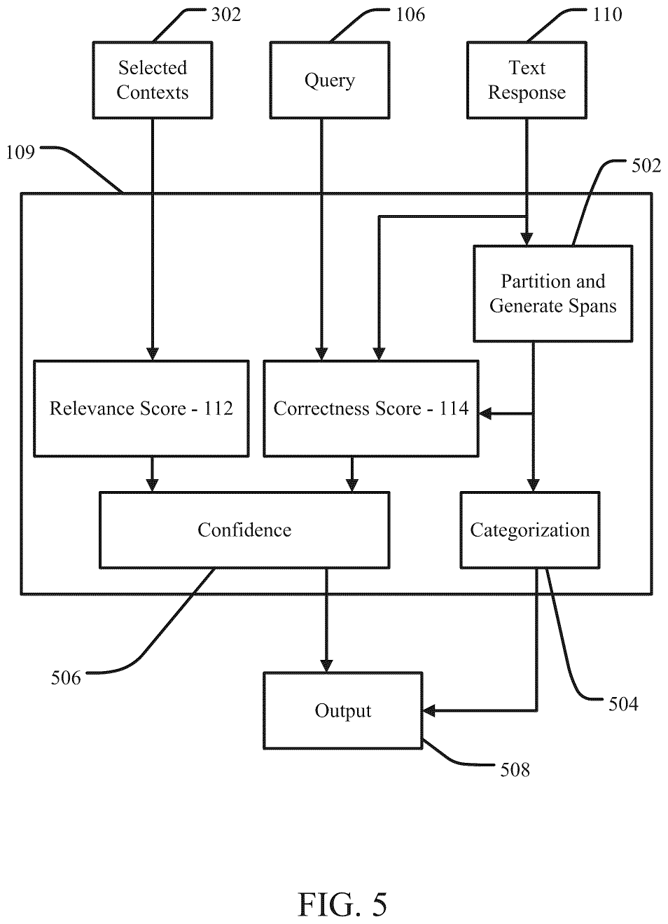

Referring to FIG. 5, a RAG checking program is illustrated in greater detail in accordance with an embodiment of the present invention. Response evaluator 109 evaluates various RAG systems in terms of their selection and generation performance using relevancy score 112 and correctness score 114. Response evaluator 109 receives RAG context 302, query 106, and response 110 as inputs. In some embodiments of the present invention RAG context 302 can be an image. In other embodiments of the present invention, other forms of data are contemplated. Query 106 is text based though any other form of natural language can also be contemplated such as videos of sign language, audio, etc. Response 110 is text based and can be generated using AI models like GenAI model 107 (FIG. 1).

Response evaluator 109 then determines relevancy score 112 and correctness score 114. Relevancy score 112 is derived from RAG context 302. Correctness score 114 is a result from query 106, response 110 and partition and generated spans 502 which are formed in response evaluator 109 from response 110.

Relevancy score 112 and correctness score 114 form confidence 506 which can be a confidence from response evaluator 109 that GenAI model 107 (FIG. 1) has a good response to query 106. The confidence score is a combination of relevance score and correctness score 114 and may be defined as multiplication of these two scores together. A good response can be relevant and correct. Response evaluator 109 can have thresholds to trigger different actions based on confidence 506. For example, a high score (above a certain threshold) can be sent to output 508 with categorization 504. Categorization 504 is derived from generated spans 502 and categorizes the spans as objective or subjective. This can allow user 102 (FIG. 1) to have a better understanding of the Gen AI model's processing. This can be especially helpful when GenAI model 107 (FIG. 1) is a black box model, though the information can be given in white box models.

Other confidence 506 values can lead response evaluator 109 to reevaluate RAG context 302 or response 110. Even further confidence 506 values below a second threshold can request that query 106 be entered again, as a means of potentially improving confidence 506. The confidence 506 can also be used to initiate a task, e.g., an online transaction, or to control a system.

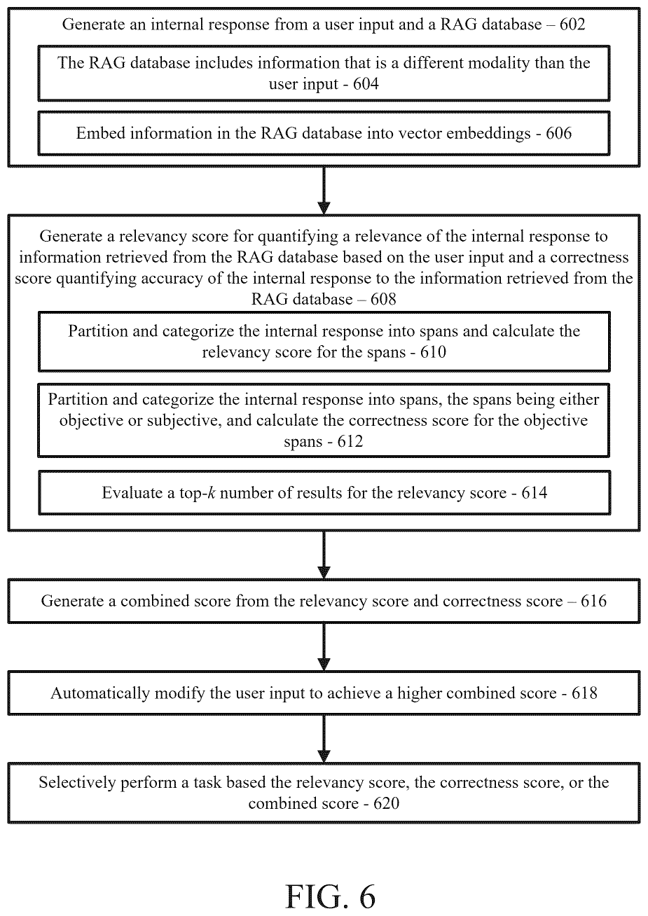

Referring to FIG. 6, a method for evaluating multimodal retrieval augmented generation performance is illustrated. In block 602, an internal response is generated from a user input and a RAG database. The internal response is a response within a RAG system, e.g., multi-modal LLM system 108 (FIG. 1), that answers a query from the user input considering the results from the RAG database. The internal response is then used for downstream processing. In other words, the internal response is a machine-language response to the user input that can be evaluated for relevancy and correctness, among other things. The internal response can also be an output viewed by the user as an image, natural language, or some other form of output. In some embodiments of the present invention, the internal response can be the output of a GenAI model.

In block 604, the RAG database includes information that is a different modality than the user input. The modalities of the RAG database, the user input, and the internal response can all the different, all be the same, or some combination. The modalities can include text, video, image, sound, etc. Other modalities are also contemplated. In block 606, the information in the RAG databases is embedded into vector embeddings. The embeddings can be one-hot encodings, frequency based, distributed word embeddings, contextual embeddings, averaging word vectors, universal sentence encoder, raw pixel embeddings, CNN feature embeddings, self-supervised image embeddings, CLIP embeddings, spectrogram embeddings, MFCC embeddings, deep audio embeddings, ALIGN, Florence, Flamingo, etc. The embeddings can be low dimensionality (50-300 dimensions), high dimensionality (768-4096 dimensions), or dynamic dimensionality. The training can be unsupervised, self-supervised, supervised, or joint training. The embeddings can be dense vectors, sparse vectors, binary embeddings, hierarchical embeddings, complex or hyperbolic embeddings, etc. The similarity can be measures through cosine similarity, Euclidean distance, dot product, Manhattan distance, Wasserstein, etc. Embeddings can be static embedding, contextual embedding, or meta embedding.

In block 608, a relevancy score is generated to quantify a relevance of the internal response to information retrieved from the RAG database based on the user input and a correctness score is generated to quantify accuracy of the internal response to the information retrieved from the RAG database. In block 610, the internal response is partitioned and categorized into spans and the relevancy score for the spans is calculated. In block 612, the internal response is partitioned and categorized into spans, the spans being either objective or subjective, and the correctness score for the objective spans is calculated.

In block 614, a top-k number of results are evaluated for relevance. In block 616, a combined score from the relevancy score and correctness score is generated. In block 618, the user input is automatically modified to achieve a higher combined score. In block 620, a task based on the relevancy score, the correctness score, or the combined score is selectively perform. The task can be performed in response to the score reaching a certain level. For example, a light switch can be actuated to turn a light on in a room when the system identifies that the window is not providing enough light with enough confidence. The prompt can be “determine if the room is too dark.” A combined score, correctness score, or relevancy score can determine whether the room is too dark. Alternatively, when a combined score, correctness score, or relevancy score is too low a task can be performed. Another example, in response to a prompt “is the room too dark” the system can send a robot to investigate the room light intensity. Other actions that can be performed are contemplated.

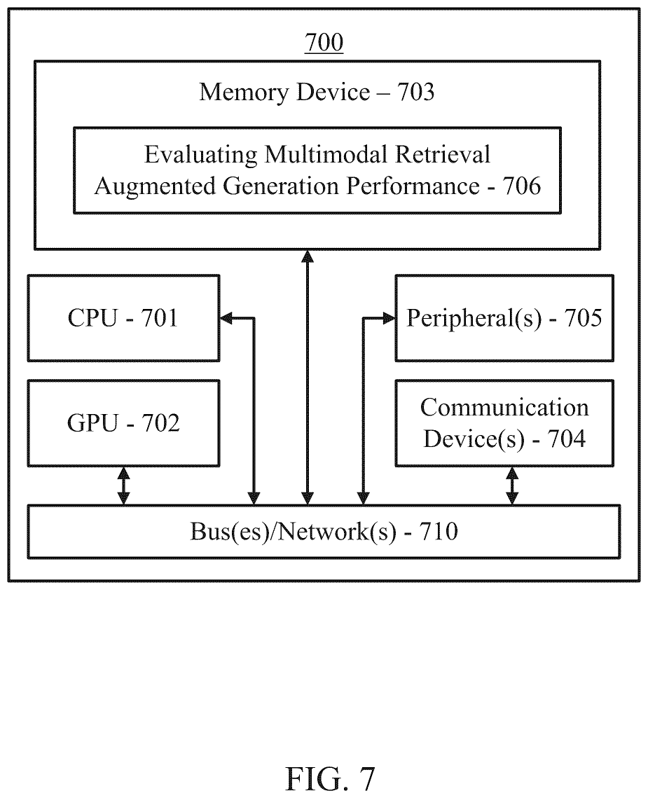

Referring to FIG. 7, a block diagram is shown for an exemplary processing system 700, in accordance with an embodiment of the present invention. The processing system 700 includes a set of processing units (e.g., CPUs) 701, a set of GPUs 702, a set of memory devices 703, a set of communication devices 704, and a set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., Wi-Fi®, etc.) adapters, etc.). The peripherals 705 can include a display device, a user input device, a printer, an imaging device, and so forth. Elements of processing system 700 are connected by one or more buses or networks (collectively denoted by the figure reference numeral 710).

In an embodiment of the present invention, memory devices 703 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 703 store program code or software 706 for evaluating multimodal RAG performance. The software 706 implements one or more functions of the systems and methods described herein for generating an internal response from a user input and a RAG database and generating a relevancy score for quantifying a relevance of the internal response to information retrieved from the RAG database based on the user input and a correctness score quantifying accuracy of the internal response to the information retrieved from the RAG database. The software also includes generating a combined score from the relevancy score and correctness score and selectively performing a task based on the relevancy score, the correctness score, or the combined score. The memory devices 703 can store program code for implementing one or more functions of the systems and methods described herein.

Of course, the processing system 700 may also include other elements (not shown), as readily contemplated by one of skill in the art, as well as omitting certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 700.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

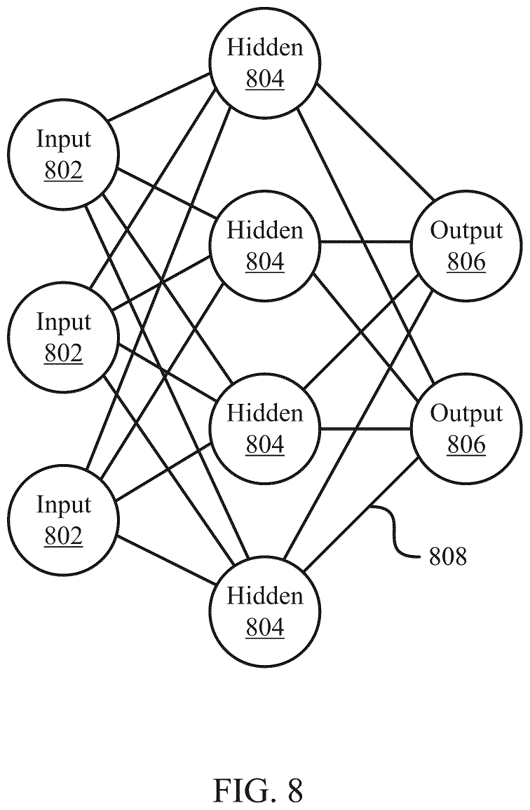

Referring to FIG. 8, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 808 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The ANN can be integrated into a multimodal RAG by having the ANN process the data to form embeddings or assess the correctness of an output. The ANN can map data from one space to another space so that the information can be compared more easily with other information.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for evaluating multimodal retrieval augmented generation (RAG) performance, comprising:
generating an internal response from a user input and a RAG database;
generating a relevancy score for quantifying a relevance of the internal response to information retrieved from the RAG database based on the user input and a correctness score quantifying accuracy of the internal response to the information retrieved from the RAG database;
generating a combined score from the relevancy score and correctness score; and
selectively performing a task based on the relevancy score, the correctness score, or the combined score.

2. The method of claim 1, wherein determining the relevancy score further comprises:
automatically modifying the user input to achieve a higher combined score.

3. The method of claim 1, further comprising:
partitioning and categorizing the internal response into spans and calculating the relevancy score for the spans.

4. The method of claim 1, further comprising:
partitioning and categorizing the internal response into spans, the spans being either objective or subjective, and calculating the correctness score for the objective spans.

5. The method of claim 1, further comprising:
evaluating a top-k number of results for the relevancy score.

6. The method of claim 1, further comprising:
embedding information in the RAG database into vector embeddings.

7. The method of claim 1, wherein the RAG database includes information that is a different modality than the user input.

8. A system for evaluating multimodal retrieval augmented generation (RAG) performance, comprising:
a processor; and
a memory storing computer-readable instructions that, when executed by the processor, cause the system to:
generate an internal response from a user input and a RAG database;
generate a relevancy score for quantifying a relevance of the internal response to information retrieved from the RAG database based on the user input and a correctness score quantifying accuracy of the internal response to the information retrieved from the RAG database;
generate a combined score from the relevancy score and correctness score; and
selectively perform a task based on the relevancy score, the correctness score, or the combined score.

9. The system of claim 8, wherein the memory further causes the system to:
automatically modify the user input to achieve a higher combined score.

10. The system of claim 8, wherein the memory further causes the system to:
partition and categorize the internal response into spans and calculate the relevancy score for the spans.

11. The system of claim 8, further comprising:
partition and categorize the internal response into spans, the spans being either objective or subjective, and calculate the correctness score for the objective spans.

12. The system of claim 8, wherein the memory further causes the system to:
evaluate a top-k number of results for the relevancy score.

13. The system of claim 8, wherein the memory further causes the system to:
embed information in the RAG database into vector embeddings.

14. The system of claim 8, wherein the RAG database includes information that is a different modality than the user input.

15. A computer program product comprising a non-transitory computer-readable storage medium containing computer program code, the computer program code when executed by one or more processors causes the one or more processors to perform operations, the computer program code comprising instructions to:
generate an internal response from a user input and a RAG database;
generate a relevancy score for quantifying a relevance of the internal response to information retrieved from the RAG database based on the user input and a correctness score quantifying accuracy of the internal response to the information retrieved from the RAG database;
generate a combined score from the relevancy score and correctness score; and
selectively perform a task based on the relevancy score, the correctness score, or the combined score.

16. The computer program code of claim 15, wherein the computer program code further includes instructions to:
automatically modify the user input to achieve a higher combined score.

17. The computer program code of claim 15, wherein the computer program code further includes instructions to:
partition and categorize the internal response into spans and calculate the relevancy score for the spans.

18. The computer program code of claim 15, wherein the computer program code further includes instructions to:
partition and categorize the internal response into spans, the spans being either objective or subjective, and calculate the correctness score for the objective spans.

19. The computer program code of claim 15, wherein the computer program code further includes instructions to:
evaluate a top-k number of results for the relevancy score.

20. The computer program code of claim 15, wherein the computer program code further includes instructions to:
embed information in the RAG database into vector embeddings.
